(19) United States
(12) Patent Application Publication
(10) Pub. No.: US 2009/0024506 A1
(43) Pub. Date: Jan. 22, 2009

(54) CELLPHONE ACTIVATED ATM TRANSACTIONS

(76) Inventor: Marc HOURI, Ashdod (IL)

Correspondence Address: DANIEL J SWIRSKY, 55 REUVEN ST., BEIT SHEMESH, 99544, IL

(21) Appl. No.: 12/174,693

(22) Filed: Jul. 17, 2008

(30) Foreign Application Priority Data
Jul. 18, 2007 (IL) IL 184701

(51) Int. Cl. G06Q 40/00; G06Q 20/00

(52) U.S. Cl. 705/35

(57) ABSTRACT

Receiving a transaction authorization request by an authorization system from an Automated Teller Machine (ATM), wherein the transaction request includes at least transaction details, identifying information and an authentication code, and wherein the authentication code is generated by software in the possession of a user requesting said transaction request; forwarding the identifying information and the authentication code to an authentication server which shares authentication secrets in common with the software; receiving authentication results of the authentication, and authorizing the transaction request in accordance with the received results.

### FIELD OF THE INVENTION

The present invention relates to user authentication generally and to authentication using mobile devices in particular.

### BACKGROUND OF THE INVENTION

Automated Teller Machines (ATMs) are typically accessed by plastic cards with electronic data encoded on a magnetic stripe or on a chip. The electronic data typically includes identifying information such as a user name and credit card account number. This information is read by a card reader on the ATM and is used to identify the user accessing the ATM. A secret Personal Identification Code (PIN) is typically input into the ATM to verify that the user is indeed authorized to access the indicated account. This is referred as authentication.

A user typically initiates an ATM session by inserting a plastic card into a card reader. The card reader reads identifying information from a magnetic stripe or from a chip located on the card. The user then uses a numeric keypad on the ATM to enter a PIN associated with the identifying information on plastic card. The user may also use the numeric keypad to select a desired transaction and to enter transaction details as relevant.

A user's PIN and the identifying information from the card can be easily stolen and re-used in order to impersonate the genuine user and perform fraudulent transactions.

In recent years the use of mobile devices, such as such as cell phones, Personal Data Assistants (PDAs) and the like, has become almost universal. Such devices typically have one or more unique identifiers associated with them such as a phone number, or a serial number such as an International Mobile Equipment Identity (IMEI). There is a trend to leverage the now ubiquitous nature of these mobile devices by using them as unique identifiers for their users when carrying out financial transactions and/or managing bank accounts.

However, the use of mobile devices for identification exposes users to the risks of fraud and theft. Accordingly, their use for the remote execution of financial transactions is problematic. In such cases, when a visual identification of the user is not possible, stolen devices and/or hacked codes may be used to “impersonate” an authorized user

### SUMMARY OF THE PRESENT INVENTION

An object of the present invention is to improve upon the prior art.

There is therefore provided, in accordance with a preferred embodiment of the present invention a method including receiving a transaction authorization request by an authorization system from an ATM, wherein the transaction request includes at least transaction details, identifying information and an authentication code, and wherein the authentication code is generated by software in the possession of a user requesting the transaction request; forwarding the identifying information and the authentication code to an authentication server which shares authentication secrets in common with the software; receiving authentication results of the authentication and authorizing the transaction request in accordance with the received results.

Further, in accordance with a preferred embodiment of the present invention, the authentication code is a one time password (OTP).

Still further, in accordance with a preferred embodiment of the present invention, the authentication code is generated on a mobile device.

Additionally, in accordance with a preferred embodiment of the present invention, the ATM comprises a numeric keypad to receive the identifying information.

Moreover, in accordance with a preferred embodiment of the present invention the ATM includes a card reader to receive the identifying information

Further, in accordance with a preferred embodiment of the present invention, the authorizing includes providing the identifying information and the transaction details to at least one financial system, wherein the financial system manages at least a degree of access to a financial account indicated by the identifying information; receiving a response from the at least one financial system wherein the response includes at least an indication whether the transaction details are acceptable; and authorizing the transaction request wherein all the received indications are acceptable.

There is also provided, in accordance with a preferred embodiment of the present invention a method including receiving a transaction authorization request by an authorization system from an ATM, wherein the transaction request includes at least: transaction details, identifying information and an authentication code, and wherein the authentication code is a digital signature; forwarding the identifying information and the authentication code to an authentication server which shares authentication secrets in common with the software; receiving authentication results of the authentication, and authorizing the transaction request in accordance with the received results.

Further, in accordance with a preferred embodiment of the present invention, the ATM includes a wireless receiver to receive the authentication code from a mobile device.

Still further, in accordance with a preferred embodiment of the present invention, the ATM includes a numeric keypad to receive the identifying information.

Additionally, in accordance with a preferred embodiment of the present invention, the ATM includes a card reader to receive the identifying information

Moreover, in accordance with a preferred embodiment of the present invention the authorizing includes providing the identifying information and the transaction details to at least one financial system wherein the financial system manages at least a degree of access to a financial account indicated by the identifying information; receiving a response from the at least one financial system wherein the response comprises at least an indication whether the transaction details are acceptable; and authorizing the transaction request wherein all the received indications are acceptable.

There is also provided, in accordance with a preferred embodiment of the present invention an ATM authorization system including means to receive a transaction request from an ATM, wherein the transaction request includes at least transaction details, identifying information and an authentication code, wherein the authentication code is at least one of an OTP and a digital signature; a connection with an authentication server; wherein the authentication server includes means to authenticate the identifying information according to the authentication code; and means to determine whether to authorize the transaction request based on at least an authentication result received via the connection from the authentication server.

Further, in accordance with a preferred embodiment of the present invention, the system also includes a connection with at least one financial system; wherein the financial system includes means to access at least an account associated with the identifying information in order to determine whether to authorize the transaction request.

There is also provided, in accordance with a preferred embodiment of the present invention an ATM including a numeric keypad to at least enter transaction details and authentication codes, wherein the authentication codes are generated by software in a user's possession; a transaction request generator to forward at least the authentication codes and user provided identifying information to an authentication server for authentication, wherein the authentication server shares authentication secrets with the software in the possession of the user.

Further, in accordance with a preferred embodiment of the present invention, the authentication codes are OTPs.

Still further, in accordance with a preferred embodiment of the present invention, the ATM also includes a wireless interface to receive the authentication codes.

There is also provided, in accordance with a preferred embodiment of the present invention a method including receiving at least transaction details and authentication codes via a numeric keypad on an ATM, wherein the authentication codes are generated by software in a user's possession; forwarding at least the authentication codes and user provided identifying information to an authentication server for authentication wherein the authentication server shares authentication secrets with the software in the possession of said user.

Further, in accordance with a preferred embodiment of the present invention, the authentication codes are OTPs.

Still further, in accordance with a preferred embodiment of the present invention, the receiving is via a wireless interface.

Additionally, in accordance with a preferred embodiment of the present invention, the receiving is from a user accessing a pre-authorized payment from the ATM, wherein the user is not associated with a financial institution that is normally serviced by the ATM.

There is also provided, in accordance with a preferred embodiment of the present invention an ATM including a numeric keypad to at least enter transaction details and authentication codes, wherein the authentication codes are digital signatures; a transaction request generator to forward at least the authentication codes and user provided identifying information to an authentication server for authentication wherein the authentication server shares authentication secrets with the software in the possession of the user.

Further, in accordance with a preferred embodiment of the present invention, the ATM also includes a wireless interface to receive the authentication codes.

There is also provided, in accordance with a preferred embodiment of the present invention a method including receiving at least transaction details and authentication codes via a numeric keypad on an ATM, wherein the authentication codes are digital signatures; forwarding at least the authentication codes and user provided identifying information to an authentication server for authentication, wherein the authentication server shares authentication secrets with the software in the possession of the user.

Further, in accordance with a preferred embodiment of the present invention, the receiving is via a wireless interface.

Still further, in accordance with a preferred embodiment of the present invention, the receiving is from a user accessing a pre-authorized payment from the ATM, wherein the user is not associated with a financial institution that is normally serviced by the ATM.

There is also provided, in accordance with a preferred embodiment of the present invention a method including receiving a credit card authentication request from a merchandising organization wherein the authentication request includes at least identifying information and an authentication code, and wherein the authentication code is generated by software in the possession of a user requesting the transaction request; forwarding the identifying information and the authentication code to an authentication server which shares authentication secrets in common with the software; receiving authentication results of the authentication, and returning the authentication results to the merchandising organization for further processing of the credit card transaction request in accordance with the received results.

Further, in accordance with a preferred embodiment of the present invention, the authentication code is an OTP.

There is also provided, in accordance with a preferred embodiment of the present invention a method including receiving a credit card authentication request from a merchandising organization wherein the authentication request includes at least identifying information and an authentication code, wherein the authentication code is a digital signature; forwarding the identifying information and the authentication code to an authentication server which shares authentication secrets in common with the software; receiving authentication results of the authentication and returning the authentication results to the merchandising organization for further processing of the credit card transaction request in accordance with the received results.

Further, in accordance with a preferred embodiment of the present invention, the merchandising organization receives the authentication code via a wireless connection with a mobile device.

### BRIEF DESCRIPTION OF THE DRAWINGS

The subject matter regarded as the invention is particularly pointed out and distinctly claimed in the concluding portion of the specification. The invention however, both as to organization and method of operation, together with objects, features, and advantages thereof, may best be understood by reference to the following detailed description when read with the accompanying drawings in which:

FIG. 1 is a schematic illustration of a novel mobile device activated ATM system constructed and operative in accordance with a preferred embodiment of the present invention; and

FIG. 2 is a schematic illustration of a novel over-the-phone credit card authentication system, constructed and operative in accordance with a preferred embodiment of the present invention;

It will be appreciated that for simplicity and clarity of illustration elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention However, it will be understood by those skilled in the art that the present invention may be practiced without these specific details. In other instances, well-known methods, procedures, and components have not been described in detail so as not to obscure the present invention.

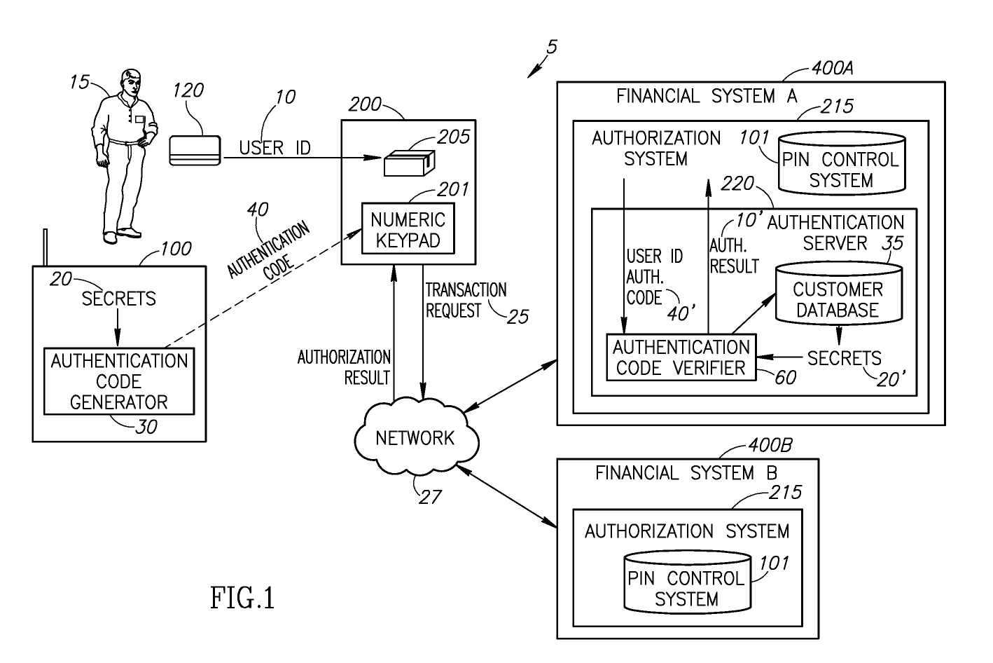

Applicants have realized that by providing a mobile device with the capability to compute identification/authentication strings, the risk of ATM fraud/theft may be reduced and a mobile device may be used to identify/authenticate users performing remote transactions. Reference is now made to FIG. 1 which illustrates a novel mobile device activated ATM transaction system 5.

System 5 may comprise a mobile device 100, an ATM 200, and a multiplicity of financial systems 400. Mobile device 100 may comprise an authentication code generator 30 which may use secrets 20 to generate an authentication code 40. Each financial system 400 may comprise an authorization system 215 to authorize ATM transactions. ATM 200 may comprise a card reader 205 and a numeric keypad 201 for entry of user information, PIN codes, transaction amounts and/or other data required for a typical ATM session.

User 15 may wish, for example, to withdraw cash from an ATM 200. User 15 may access ATM 200 with a user ID 10. User ID 10 may be entered as in the prior art by inserting a plastic card 120 with a magnetic stripe or a chip into card reader 205. Alternatively, in accordance with a preferred alternative embodiment of the present invention user 15 may manually enter user ID 10 on numeric keypad 201.

After entering user ID 10, user 15 may then use authentication code generator 30 to generate an authentication code 40 to be input to ATM 200. In accordance with a preferred alternative embodiment of the present invention, authentication code 40 may be a one time password (OTP). An OTP is typically computed using one or more dynamic elements, such as, for example, the current time, to generate a seemingly random password that may be valid for one time usage and may have a limited lifespan Once an OTP may have been used, or if a given time interval has elapsed, it may no longer be valid and a new OTP must be generated. U.S. Pat. No. 6,957,185, hereby incorporated in its entirety by reference, discloses a system and method that may be used to generate such OTPs on a cell phone. User 15 may enter a PIN to activate authentication code generator 30. Authentication code generator 30 may not activate or may provide false codes if the appropriate PIN is not entered. Authentication code generator 30 may use secrets 20 as a basis for generating a new authentication code 40, incorporating secrets 20 with a dynamic element such as the current time. It will therefore be appreciated that in order to authenticate authentication code 40, both the dynamic element and secrets 20 must be known by the authentication server that verifies the authentication code.

In summary, user 15 may first access ATM 200 by inserting plastic card 120 into card reader 205 or by manually inputting user ID 10 on keypad 201. User 15 may then run authentication code generator 30 on mobile device 100 in order to generate an authentication code 40. Authentication code 40 may be used to authenticate user ID 10 instead of a PIN as in the prior art.

ATM 200 may forward a transaction authorization request 25 via network 27 for processing. Transaction authorization request 25 may comprise copies of user ID 10, authentication code 40 and transaction details, such as an amount to withdraw. It will be appreciated that user ID 10 may indicate which financial system 400 may be appropriate for such processing. An exemplary such financial system 400 may be financial system 400A as shown in FIG. 1. Financial system 400A may comprise an authorization system 215. Authorization system 215 may comprise an authentication server 220 for authenticating authentication codes 40, and a PIN control system 101 for performing prior art authentication. Financial system 400B may represent an exemplary prior art financial system 400, with only a PIN control system 101 to authenticate users of ATM 200.

Authorization system 215 may verify authentication code 40 by transferring copies of user ID 10 and authentication code 40 (herein labeled 10′ and 40′ respectively) in a request for authentication to an authentication server 220. Authentication server 220 may provide authentication services to financial system 400A typically as a condition for authorizing one or more actions. Authentication servers, such as authentication server 220, may utilize a variety of authentication algorithms including, for example, passwords, Kerberos, and public key encryption.

Authentication server 220 may comprise an authentication code verifier 60 and a customer database 35. Authentication server 220 may fetch a copy of secrets 20, herein labeled secrets 20′, from customer database 35 using user If) 10′. It will be appreciated that without secrets 20′ and knowledge regarding the dynamic element used by authentication code generator 30, it may be impossible to authenticate user ID 10 with authentication code 40. It will therefore be appreciated that the software for authentication code generator 30 and authentication server 220 as well as secrets 20 and 20′ must be synchronized in advance in order to operate system 5.

Authentication server 220 may be any authentication server capable of using authentication code 40′ and user ID 10′ to authenticate user 15. In accordance with a preferred embodiment of the present invention authentication server 220 may be capable of authenticating OTPs. An exemplary such authentication server 220 is disclosed in U.S. Pat. No. 6,957,185.

Authentication code verifier 60 may use secrets 20′ associated with user ID 10′ to authenticate authentication code 40′ with respect to one or more dynamic elements included in the generation of code 40′. Authentication server 220 may return an authentication result to authorization system 215. If, as per the authentication result, user ID 10′ may have been successfully authenticated, authorization system 215 may then proceed with authorizing the transaction details of transaction request 25 as in a typical ATM authorization system

If user ID 10′ may not be successfully authenticated, authentication server 220 may return a negative authentication result to authorization system 215, and authorization system 215 may forward a negative authorization result 26 to ATM 200 in order to stop the transaction process. The authorization result may comprise details of a failed authentication and ATM 200 may prompt user 15 to try again.

In the event that a positive authentication result may have been received from authorization system 215, transaction request 25 may still fail to receive authorization depending on the information regarding any accounts associated with user ID 10′ in financial system 400A If the authorization results are positive, ATM 200 may then execute the transaction requested. If the authorization results are negative, user 15 may be provided with an explanatory message. It will be appreciated that authorization system 215, authentication server 220, and/or ATM 200 may have pre-defined upper limits for unsuccessful authentication attempts.

It will be appreciated that user 15 need not possess a plastic card 120 for identification in order to complete a transaction according to the invention presented. Identification and authentication may be input to ATM 200 without using a plastic card for delivery. It will further be appreciated that authentication code 40 may comprise a dynamic element and may therefore not be reused, thus preventing misuse by persons attempting to intercept authentication code 40 as it is entered.

It will be appreciated that the use of a cash withdrawal transaction may be exemplary. The present invention may include any “remote transaction”. A remote transaction may refer to any transaction accomplished without personal verification of the identification of an account owner by a representative of the financial institution. Examples of such transactions may include: an ATM transaction, an over-the-phone transaction a check based transaction, a fax based transaction, on-the-spot, e-commerce, or automatic dispenser. In general, “remote transaction” refers to any transaction affecting the account moneys whereas the identity of the user performing the transaction cannot be verified in person by an authorized official.

ATMs may typically be subject to sharing agreements between different financial institutions. For example, an ATM 200 belonging to institution A may honor cash withdrawal requests by a customer of institution B. It will therefore be appreciated that user 15 may not have an account with the institution responsible for running the ATM 200. Instead, user 15 may be a customer of an institution B which may have an agreement to use ATMs 200 belonging to institution A for cash withdrawals and other financial services.

Existing ATMs may typically be configured to receive a numeric PIN of four to six digits length. In accordance with a preferred embodiment of the present invention, an authentication code 40 may also comprise four to six numeric digits. It will accordingly be appreciated that the present invention may be implemented on current ATMs without requiring changes to either hardware or software. ATM systems may forward authentication codes 40 “downstream” in the same manner that they currently handle PIN codes.

It will, however, be appreciated that in order to enable a user to enter a user ID 10 via keypad 201 (instead of using a plastic card for delivery) a software update may be necessary at the level of ATM 200 and at the level of authorization system 215.

In accordance with another preferred alternative embodiment of the present invention authentication code 40 may be a digital signature computed or received in the cell phone. Digital signatures are typically too long to be reliably entered in a manual process. In accordance with an alternative preferred embodiment of the present invention mobile device 100 may be equipped with a wireless transmission capability for forwarding authentication code 40 or digital signature to ATM 200. Such capability may use, for example, at least one of the following technologies: infrared (IR), Bluetooth, Near Field Communication, WIFI or a connection via a mobile network. ATM 200 may be similarly equipped with a corresponding capability to receive authentication code 40. In order to process a digital signature, any PKI toolkit suitable for verifying a digital signature may be used as authentication server 60.

It will be appreciated that using either digital signatures or OTPs as authentication codes may provide an enhanced measure of protection against theft by observation A digital signature may not be entered via a keypad and accordingly it may not be easily observed by someone as it is input into an ATM. While the entry of an OTP may indeed be observed in the same way that a PIN may be observed, the exposure may be minimal because an OTP may not be re-used.

In accordance with a preferred embodiment of the present invention user 15 may not have an account with a financial institution serviced by ATM 200. User 15 may receive notification of a pre-authorized transaction in his favor made by another entity. Such a pre-authorized transaction may, for example, be a payment to user 15 by any entity. The notification may include a user ID 10 and directions for downloading authentication code generator 30 to a mobile device 100 associated with user 15. User 15 may activate authentication code generator 30 and generate an authentication code 40. User 15 may then access ATM 200 by entering the received user ID 10 and the generated authentication code 40. User 15 may withdraw all or part of the amount to be paid as per the embodiments described hereinabove, even without being otherwise associated with any of the institutions that own or operate the component parts of system 5.

The notification may be sent directly to mobile device 100 via any suitable means, such as: SMS, email, or voice message. Alternatively, the notification may be provided in any alternative form.

Once the user has the authentication code generator 30 in his mobile device 100, he doesn't need to download it again at the next reception of notification of a pre-authorized transaction in his favor.

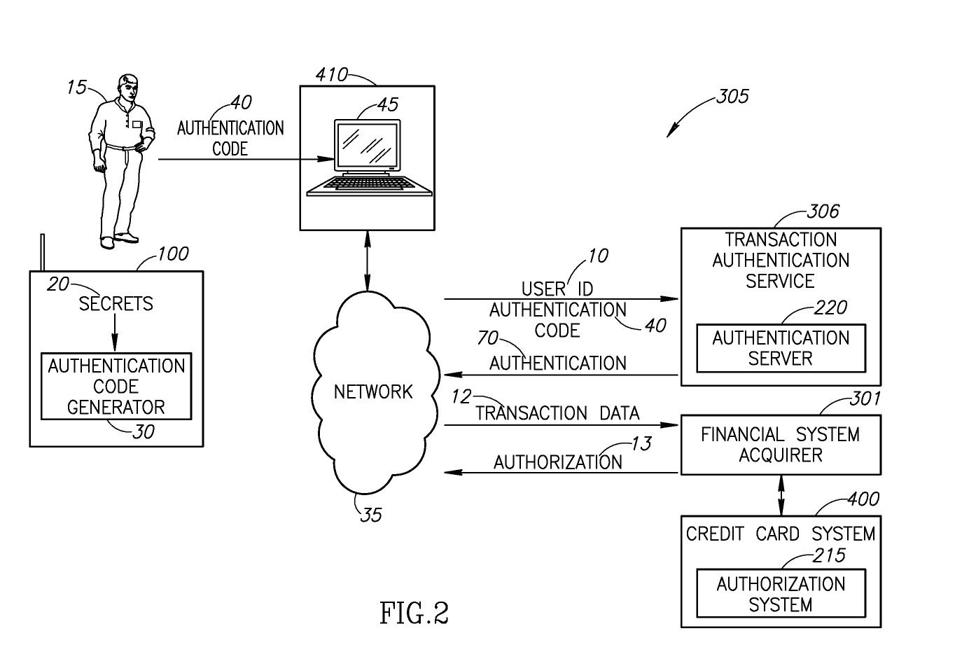

In accordance with another preferred embodiment of the present invention authentication code generator 30 may be used to facilitate “card-not-present” credit card based transactions. “Card-not-present” transactions may be credit card transactions in which the user of a credit card does not (for whatever reason) show corroborating identification at the time of the transaction. For example, an over-the-phone credit card purchase is a “card-not-present” transaction. FIG. 2, to which reference is now made, illustrates a novel ” card-not-present” credit card authentication system 305. System 305 comprises a mobile device 100, a personal computer PC 45 located in a store 410, and a transaction authentication service 306. Transaction authentication service 306 may provide an existing credit card system 400 improved security for remote transactions over the phone.

Mobile device 100 may run an authentication code generator 30 as in the previous embodiments. However, instead of providing authentication codes 40 for use with ATM transaction, authentication code generator 30 may provide authentication codes 40 for use with “card-not-present” credit card transactions.

User 15 may be a registered user of transaction authentication service 306. User 15 may wish to purchase something from store 410. It will be appreciated that the merchant will also be a participant merchant or any participant organization registered with transaction authentication service 306 for authentication of “card-not-present” transactions. PC 45 may be operated by a cashier (not shown) at the store 410, and may be any standard personal computer capable of browsing websites via a network 35. It will be appreciated that the merchant may be able to use any suitable communication device to communicate with the transaction authentication service 306.

User 15 may call store 410 using any communication network including the PSTN. Alternatively, user 15 may appear in person at store 410.

User 15 may declare that he is a registered user with transaction authentication service 306, and uses authentication system 305 to authenticate himself In order to do so, user 15 may activate authentication code generator 30 on mobile device 100 to generate an authentication code 40 and provide it to the cashier. The cashier may forward user ID 10 (as may also be provided by user 15) and authentication code 40 to transaction authentication service 306 for user authentication. Transaction authentication service 306 may use user ID 10 and authentication code 40 to provide an authentication 70 as per the processing described in the previous embodiments. If, eventually, authentication 70 is positive, the requested transaction may then be processed as per current typical processing for credit card payment.

It will be appreciated that service 306 may be used in addition to typical “card-not-present” credit card processing. Once authentication result 70 may be received, PC 45 may send transaction data 12 to financial system acquirer 301. Financial system acquirer 301 may interact with credit card system 400 regarding the transaction and may return authorization 13 to PC 45. However, the prior communication with transaction authentication service 306 may provide enhanced confidence for the authentication of user 15 and may reduce exposure to credit card fraud.

Unless specifically stated otherwise, as apparent from the preceding discussions, it is appreciated that, throughout the specification discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein or it may prove convenient to construct a more specialized apparatus to perform the desired method. The desired structure for a variety of these systems will appear from the description below. In addition embodiments of the present invention are not described with reference to any particular programming language. It will be appreciated that a variety of programming languages may be used to implement the teachings of the invention as described herein

While certain features of the invention have been illustrated and described herein many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
receiving a transaction authorization request by an authorization system from an Automated Teller Machine (ATM), wherein said transaction request comprises at least: transaction details, identifying information and an authentication code, and wherein said authentication code is generated by software in the possession of a user requesting said transaction request;
forwarding said identifying information and said authentication code to an authentication server which shares authentication secrets in common with said software;
receiving authentication results of said authentication, and
authorizing said transaction request in accordance with said received results.

2. The method according to claim 1 and wherein said authentication code is a one time password (OTP).

3. The method according to claim 1 and wherein said authentication code is generated on a mobile device.

4. The method according to claim 1 and wherein:
said ATM comprises a numeric keypad to receive said identifying information.

5. The method according to claim 1 and wherein:
said ATM comprises a card reader to receive said identifying information.

6. The method according to claim 1 and wherein said authorizing comprises:
providing said identifying information and said transaction details to at least one financial system, wherein said financial system manages at least a degree of access to a financial account indicated by said identifying information;
receiving a response from said at least one financial system, wherein said response comprises at least an indication whether said transaction details are acceptable; and
authorizing said transaction request wherein all said received indications are acceptable.

7. A method comprising:
receiving a transaction authorization request by an authorization system from an Automated Teller Machine (ATM), wherein said transaction request comprises at least: transaction details, identifying information and an authentication code, wherein said authentication code is a digital signature;
forwarding said identifying information and said authentication code to an authentication server which shares authentication secrets in common with said software;
receiving authentication results of said authentication, and
authorizing said transaction request in accordance with said received results.

8. The method according to claim 7 and wherein said ATM comprises a wireless receiver to receive said authentication code from a mobile device.

9. The method according to claim 7 and wherein:
said ATM comprises a numeric keypad to receive said identifying information.

10. The method according to claim 7 and wherein:
said ATM comprises a card reader to receive said identifying information.

11. The method according to claim 7 and wherein said authorizing comprises:
providing said identifying information and said transaction details to at least one financial system, wherein said financial system manages at least a degree of access to a financial account indicated by said identifying information;
receiving a response from said at least one financial system, wherein said response comprises at least an indication whether said transaction details are acceptable; and
authorizing said transaction request wherein all said received indications are acceptable.

12. An ATM authorization system comprising:
means to receive a transaction request from an ATM, wherein said transaction request comprises at least: transaction details, identifying information and an authentication code, wherein said authentication code is at least one of: an OTP and a digital signature;
a connection with an authentication server; wherein said authentication server comprises means to authenticate said identifying information according to said authentication code; and
means to determine whether to authorize said transaction request based on at least an authentication result received via said connection from said authentication server.

13. The authorization system according to claim 12 and also comprising:
a connection with at least one financial system; wherein said financial system comprises means to access at least an account associated with said identifying information in order to determine whether to authorize said transaction request.

14. An ATM comprising:
a numeric keypad to at least enter transaction details and authentication codes, wherein said authentication codes are generated by software in a user's possession;
a transaction request generator to forward at least said authentication codes and user provided identifying information to an authentication server for authentication, wherein said authentication server shares authentication secrets with said software in the possession of said user.

15. The ATM according to claim 14 and wherein said authentication codes are OTPs.

16. The ATM according to claim 14 and also comprising:
a wireless interface to receive said authentication codes.

17. A method comprising:
receiving at least transaction details and authentication codes via a numeric keypad on an ATM, wherein said authentication codes are generated by software in a user's possession;
forwarding at least said authentication codes and user provided identifying information to an authentication server for authentication, wherein said authentication server shares authentication secrets with said software in the possession of said user.

18. The method according to claim 17 and wherein said authentication codes are OTPs.

19. The method according to claim 17 and wherein said receiving is via a wireless interface.

20. The method according to claim 17 and wherein said receiving is from a user accessing a pre-authorized payment from said ATM, wherein said user is not associated with a financial institution that is normally serviced by said ATM.

21. An ATM comprising:
a numeric keypad to at least enter transaction details and authentication codes, wherein said authentication codes are digital signatures;
a transaction request generator to forward at least said authentication codes and user provided identifying information to an authentication server for authentication, wherein said authentication server shares authentication secrets with said software in the possession of said user.

22. The ATM according to claim 21 and also comprising:
a wireless interface to receive said authentication codes.

23. A method comprising:
receiving at least transaction details and authentication codes via a numeric keypad on an ATM, wherein said authentication codes are digital signatures;
forwarding at least said authentication codes and user provided identifying information to an authentication server for authentication, wherein said authentication server shares authentication secrets with said software in the possession of said user.

24. The method according to claim 23 and wherein said receiving is via a wireless interface.

25. The method according to claim 23 and wherein said receiving is from a user accessing a pre-authorized payment from said ATM, wherein said user is not associated with a financial institution that is normally serviced by said ATM.

26. A method comprising:
receiving a credit card authentication request from a merchandising organization, wherein said authentication request comprises at least: identifying information and an authentication code, wherein said authentication code is generated by software in the possession of a user requesting said transaction request;
forwarding said identifying information and said authentication code to an authentication server which shares authentication secrets in common with said software;
receiving authentication results of said authentication, and
returning said authentication results to said merchandising organization for further processing of said credit card transaction request in accordance with said received results.

27. The method according to claim 26 and wherein said authentication code is an OTP.

28. A method comprising:
receiving a credit card authentication request from a merchandising organization, wherein said authentication request comprises at least: identifying information and an authentication code, wherein said authentication code is a digital signature;
forwarding said identifying information and said authentication code to an authentication server which shares authentication secrets in common with said software;
receiving authentication results of said authentication, and
returning said authentication results to said merchandising organization for further processing of said credit card transaction request in accordance with said received results.

29. The method according to claim 28 and wherein said merchandising organization receives said authentication code via a wireless connection with a mobile device.
